(19) United States
(12) Patent Application Publication
(10) Pub. No.: US 2024/0241610 A1
(43) Pub. Date: Jul. 18, 2024

(54) METHOD FOR MANUFACTURING CONDUCTIVE MESH, THIN FILM SENSOR AND METHOD FOR MANUFACTURING THE SAME

(71) Applicants: Beijing BOE Technology Development Co., Ltd., Beijing (CN); BOE TECHNOLOGY GROUP CO., LTD., Beijing (CN)

(72) Inventors: Mengwen JIA, Beijing (CN); Jian ZHOU, Beijing (CN); Feng QU, Beijing (CN); Biqi LI, Beijing (CN)

(21) Appl. No.: 18/016,707

(22) PCT Filed: Feb. 28, 2022
(86) PCT No.: PCT/CN2022/078335

§ 371 Date: Jan. 18, 2023

(51) Int. Cl. G06F 3/044

(52) U.S. Cl. CPC G06F 3/0446; G06F 2203/04103; G06F 2203/04112

(57) ABSTRACT

The present disclosure provides a method for manufacturing a conductive mesh, a thin film sensor and a method for manufacturing the thin film sensor. The method for manufacturing the conductive mesh includes: providing a dielectric substrate; forming a first pattern layer having a first trench portion in a mesh shape on the dielectric substrate; forming a first dielectric layer formed with a second trench portion in a mesh shape on a side of the first pattern layer away from the dielectric substrate, one of the first dielectric layer and the first pattern layer is made of an organic material, and the other of the first dielectric layer and the first pattern layer is made of an inorganic material; forming a conductive material in the second trench portion on a side of the first dielectric layer away from the dielectric substrate so as to form a conductive mesh.

### TECHNICAL FIELD

The present disclosure relates to the technical field of electronic devices, and particularly relates to a method for manufacturing a conductive mesh, a thin film sensor and a method for manufacturing the thin film sensor.

### BACKGROUND

At present, a width of a line manufactured by a micro-nano processing technology commonly used in a glass-based semiconductor industry ranges from about 2 μm to about 3 μm. However, some thin film display and sensing devices, such as transparent microwave devices and the like, put higher requirements on the width of the line manufactured by the micro-nano processing. For the transparent microwave devices, a metal mesh is generally used as a unit for transmitting and receiving signals, and the arrangement of the metal mesh inevitably results in reduction in transmittance, therefore, how to further improve the transmittance becomes a key point of the next research.

### SUMMARY

The present disclosure aims to solve at least one technical problem in the related art and provides a method for manufacturing a conductive mesh, a thin film sensor and a method for manufacturing the thin film sensor.

In a first aspect, an embodiment of the present disclosure provides a method for manufacturing a conductive mesh, including:
providing a dielectric substrate;
forming a first pattern layer on a side of the dielectric substrate through a patterning process, the first pattern layer having a first trench portion in a mesh shape;
forming a first dielectric layer on a side of the first pattern layer away from the dielectric substrate, the first dielectric layer being formed therein with a second trench portion in a mesh shape, with one of a material of the first dielectric layer and a material of the first pattern layer being an organic material, and the other of the material of the first dielectric layer and the material of the first pattern layer being an inorganic material; and
forming, on a side of the first dielectric layer away from the dielectric substrate, a conductive material in the second trench portion to form a conductive mesh.

In some implementations, the forming a first pattern layer on a side of the dielectric substrate through a patterning process includes:
depositing a second dielectric material layer on the dielectric substrate and curing the second dielectric material layer;
forming a third dielectric material layer on a side of the second dielectric material layer away from the dielectric substrate, and performing a patterning process on the third dielectric material layer to form a third dielectric layer with a first hollow-out pattern therein;
etching the second dielectric material layer by taking the third dielectric layer as a mask to form a second dielectric layer with a second hollow-out pattern therein;
removing the third dielectric layer, so that the second dielectric layer serves as the first pattern layer, and the second hollow-out pattern serves as the first trench portion.

In some implementations, the performing a patterning process on the third dielectric material layer to form a third dielectric layer with a first hollow-out pattern therein includes: forming the third dielectric layer with the first hollow-out pattern by wet etching.

In some implementations, the etching the second dielectric material layer by taking the third dielectric layer as a mask to form a second dielectric layer with a second hollow-out pattern includes: performing dry etching on the second dielectric material layer to form the second dielectric layer with the second hollow-out pattern therein.

In some implementations, a width of the first trench portion is W1, a width of the second trench portion is W2, a thickness of the first dielectric layer is d, and (W1−W2)=1.2×d.

In some implementations, a difference between refractive indices of the first dielectric layer and the second dielectric layer is not greater than 1%.

In some implementations, a material of the first dielectric layer includes silicon nitride or silicon oxide.

In some implementations, a material of the second dielectric layer includes an organic glue.

In some implementations, the forming, on a side of the first dielectric layer away from the dielectric substrate, a conductive material in the second trench portion to form a conductive mesh includes:
sequentially depositing a metal film and photoresist on a side of the third dielectric material layer away from the dielectric substrate by an electron beam evaporation apparatus, and forming metal material located in the second trench portion through exposure, development and etching, so as to form the conductive mesh.

In some implementations, the forming, on a side of the first dielectric layer away from the dielectric substrate, a conductive material in the second trench portion to form a conductive mesh includes:
forming a metal film serving as a seed layer on a side of the third dielectric material layer away from the dielectric substrate;
electroplating on the seed layer to form metal material in the second trench portion and on a side of the third dielectric material layer away from the dielectric substrate; and
removing at least the metal material outside the second trench portion to form the metal material located in the second trench portion, so as to form the conductive mesh.

In some implementations, the providing a dielectric substrate includes: providing a first dielectric sub-substrate, and forming a second dielectric sub-substrate on the first dielectric sub-substrate, the second dielectric sub-substrate includes a flexible substrate.

In some implementations, the method for manufacturing the conductive mesh further includes: forming a buffer layer on the dielectric substrate before forming the first pattern layer.

In a second aspect, an embodiment of the present disclosure provides a method for manufacturing a thin film sensor, including the method for manufacturing the conductive mesh described above.

In a third aspect, the present disclosure provides a thin film sensor, including:
a dielectric substrate;
a first pattern layer arranged on the dielectric substrate and provided with a first trench portion in a mesh shape;
a first dielectric layer arranged on a side, away from the dielectric substrate, of the first pattern layer, formed with a second trench portion in a mesh shape therein, with one of a material of the first dielectric layer and a material of the first pattern layer including an organic material, and the other of the material of the first dielectric layer and the material of the first pattern layer including an inorganic material; and
a conductive mesh arranged on a side of the first dielectric layer away from the dielectric substrate, with an orthographic projection of the conductive mesh on the dielectric substrate being located within an orthographic projection of the first dielectric layer on the dielectric substrate.

In some implementations, a difference between refractive indices of the material of the first dielectric layer and the material of the first pattern layer is not greater than 1%.

In some implementations, the material of the first dielectric layer includes silicon nitride or silicon oxide.

In some implementations, the material of the first pattern layer includes an organic glue.

### BRIEF DESCRIPTION OF DRAWINGS

FIG. 1 is a schematic structural diagram of an exemplary thin film sensor.

FIG. 2 is a schematic cross-sectional diagram of a structure of the thin film sensor shown in FIG. 1 taken along a line A-A′.

FIG. 3 is a process flow diagram of a method for manufacturing a metal mesh in a first example of the present disclosure.

FIG. 4 is a process flow diagram of a method for manufacturing a metal mesh in a second example of the present disclosure.

FIG. 5 is a process flow diagram of a method for manufacturing a metal mesh in a third example of the present disclosure.

FIG. 6 is a process flow diagram of a method for manufacturing a metal mesh in a fourth example of the present disclosure.

FIG. 7 is a process flow diagram of a method for manufacturing a metal mesh in a fifth example of the present disclosure.

FIG. 8 is a top view of a first pattern layer formed by a method for manufacturing a metal mesh according to an embodiment of the present disclosure.

FIG. 9 is a top view of a first dielectric layer formed by a method for manufacturing a metal mesh according to an embodiment of the present disclosure.

FIG. 10 is a top view of a metal mesh formed by a method for manufacturing a metal mesh according to an embodiment of the present disclosure.

FIG. 11 is a schematic diagram of a first trench portion and a second trench portion formed by a method for manufacturing a metal mesh according to an embodiment of the present disclosure.

FIG. 12 is a cross-sectional diagram of a metal mesh in an example of the present disclosure.

### DETAIL DESCRIPTION OF EMBODIMENTS

In order to make the technical solutions of the present disclosure better understood, the present disclosure is further described in detail below with reference to the accompanying drawings and the detailed implementations.

Unless defined otherwise, technical or scientific terms used herein shall have the ordinary meaning as understood by one of ordinary skill in the art to which the present disclosure belongs. The terms “first,” “second,” and the like, as used in the description, do not denote any order, quantity, or importance, but rather are used to distinguish one element from another. Also, the use of the terms “a,” “an,”, “the” or the like does not denote a limitation of quantity, but rather denotes the presence of at least one. The word “comprising/including” or “comprises/includes”, and the like, means that the element or item preceding the word includes the element or item listed after the word and its equivalent, but does not exclude other elements or items. The terms “connecting” or “coupling” and the like are not restricted to physical or mechanical connections, but may include electrical connections, whether direct or indirect. The words “upper/on”, “lower/below”, “left”, “right”, and the like are used only to indicate relative positional relationships, and when an absolute position of the object being described is changed, the relative positional relationships may be changed accordingly.

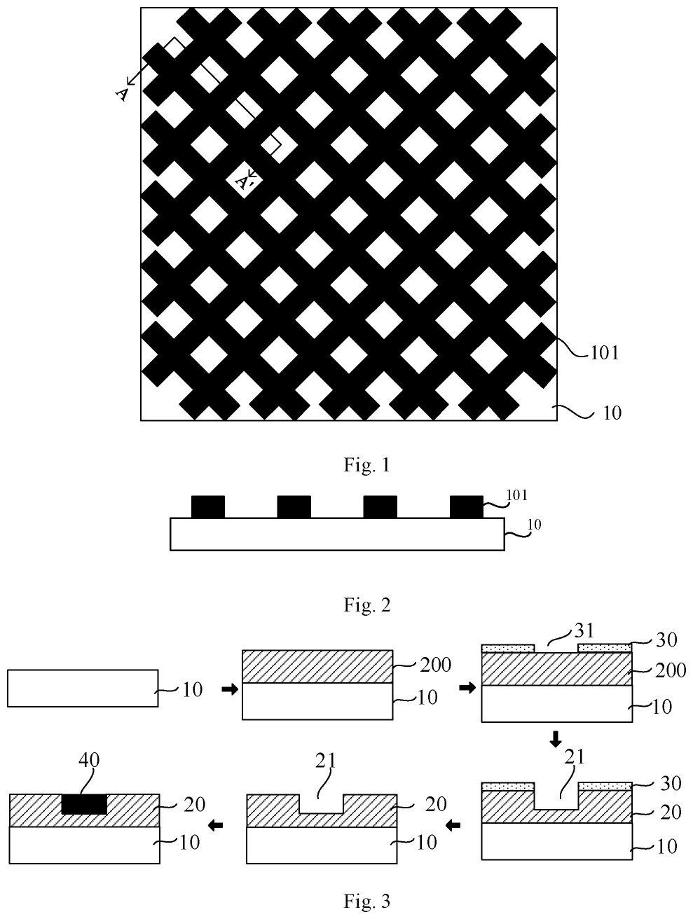

FIG. 1 is a schematic diagram of an exemplary thin film sensor; FIG. 2 is a schematic cross-sectional diagram of a structure of the thin film sensor shown in FIG. 1 taken along a line A-A′, and as shown in FIGS. 1 and 2, the thin film sensor includes: a dielectric substrate 10 and a first conductive layer 101 disposed on the dielectric substrate 10. Taking the thin film sensor serving as a transparent antenna as an example, the first conductive layer 101 may be a radiation layer. The radiation layer may serve as a receiving unit of the transparent antenna, or may serve as a transmitting unit of the transparent antenna.

In order to ensure that the first conductive layer 101 has good light transmittance, the first conductive layer 101 is required to be patterned, for example, the first conductive layer 101 may be formed by mesh lines made of a metal material. It is understood that the first conductive layer 101 may also be formed by a structure having other patterns, for example, the first conductive layer 101 may be formed by block electrodes with patterns such as diamond, triangle, and the like, which are not listed here. As can be seen from FIG. 1, the first conductive layer 101, i.e., the mesh lines, is disposed on each of surfaces, but does not cover the entire surface, of the dielectric substrate 10. Any mesh line is composed of conductive meshes that are electrically connected, and since each conductive mesh is usually made of a metal material and thus may be referred to as a metal mesh. Due to the material and process of forming the metal mesh, a line of the metal mesh has a relatively large width, which seriously influences the light transmittance of the thin film sensor, and influences a use experience of a user.

It should be noted that the metal mesh is not limited to be applied in a structure of the antenna, and may also be applied in a touch panel to serve as a touch electrode. Certainly, the metal mesh may also be applied in various metal wires, which are not listed here.

In a first aspect, in order to solve the above technical problem, a method for manufacturing a metal mesh is provided in an embodiment of the present disclosure. In the embodiment of the present disclosure, only a case where the metal mesh is applied to the antenna as a receiving unit and/or a transmitting unit of the antenna is taken as an example, but it should be understood that this does not limit the scope of the embodiment of the present disclosure.

FIG. 3 is a process flow diagram of a method for manufacturing a metal mesh in a first example of the present disclosure, as shown in FIG. 3, the method for manufacturing the metal mesh 40 may include the following steps S11 to S13.

At step S11, providing a dielectric substrate 10.

The dielectric substrate 10 may be a glass substrate, a flexible substrate, or a structure in which a glass substrate and a flexible substrate are stacked. The flexible substrate may be made of at least one of COP (cyclo olefin polymer) film, Polyimide (PI), or polyethylene terephthalate (PET). In a case where the dielectric substrate 10 is formed by the structure in which the glass substrate and the flexible substrate are stacked, the glass substrate and the flexible substrate may be bonded by a transparent optically clear adhesive (OCA) and then cleaned.

At step S12, forming a first pattern layer 20 through a patterning process, with the first pattern layer 20 having a first trench portion 21 in a mesh shape.

A material of the first pattern layer 20 may be an inorganic material such as silicon oxide or silicon nitride, and certainly, may also be organic glue, for example, SOC (Synthetic Organic Compound) glue, HR-1201 glue or MR-1301 glue.

In a case where the material of the first pattern layer 20 is the inorganic material such as silicon oxide or silicon nitride, the step S12 may include: forming a material layer made of silicon oxide or silicon nitride on a surface of the dielectric substrate 10 by a Physical Vapor Deposition (PVD) method or a Chemical Vapor Deposition (CVD) method, and the like, and then forming the first pattern layer 20 by performing an exposure, a development, and an etching process on the material layer. A thickness of the material layer made of silicon oxide or silicon nitride ranges from about 4 μm to 5 μm.

In a case where the material of the first pattern layer 20 is the organic glue, the step S12 may include: coating the organic glue on the dielectric substrate 10, then curing the organic glue, and next forming photoresist 30, exposing and developing the photoresist 30 to form a pattern (the pattern of the photoresist is denoted by 31), then performing dry etching by RIE (Reactive Ion Etching) or ICP (Inductively Coupled Plasmas Etching) on the organic glue to form a first trench portion 21 in a mesh shape, and finally removing the photoresist 30.

At step S13, forming a metal mesh 40 on a side of the first pattern layer 20 away from the dielectric substrate 10.

For example, the step S13 may include: evaporating a metal film on the side of the first pattern layer 20 away from the dielectric substrate 10 by using an electron beam evaporation apparatus, in such case, a height difference exists in the metal film since the first pattern layer 20 is formed with the first trench portion 21 therein; and then, spin-coating photoresist on a side of the metal film away from the dielectric substrate 10, then performing an exposure and a development on the photoresist, next performing etching on the metal film, and after the etching, stripping off the photoresist to form the metal material in the first trench portion 21, so as to form the metal mesh 40.

For another example, the step S13 may further include the following steps S131 to S133.

At step S131, sequentially depositing a titanium film and a copper film, i.e., forming a metal film, on a side of the first pattern layer 20 away from the dielectric substrate 10 by a process including, but not limited to, sputtering.

It should be noted that only the copper film may be deposited in this step, and the titanium film is used to increase adhesion of the copper film.

At step S132, taking the metal film 400 as a seed layer, and electroplating on the seed layer.

In some implementations, the step S132 specifically includes: placing a side of the dielectric substrate 10 having the first pattern layer 20 formed thereon on a carrier of an electroplating machine, pressing an electricity-applying pad on the dielectric substrate, placing the dielectric substrate in a hole-filling electroplating tank (a dedicated hole-filling electroplating solution being used in the tank), applying a current to the electricity-applying pad so that the electroplating solution keeps flowing continuously and rapidly on the surface of the dielectric substrate 10, cations in the electroplating solution on a side wall of the first trench portion 21 capture electrons and become atoms to be deposited on the side wall, and by using the dedicated hole-filling electroplating solution with specific formulation, metal copper can be mainly deposited in the first trench portion 21 at a relatively high deposition rate (ranging from 0.5 μm/min to 3 μm/min), while the deposition rate of the metal copper on the first pattern layer 20 is extremely small (ranging from 0.005 μm/min to 0.05 μm/min). With the increase of time, the metal copper on the side wall of the first trench portion 21 grows gradually to be thicker, and even can completely fill the first trench portion 21, and finally the dielectric substrate 10 is taken out and cleaned by using deionized water.

At step S133, removing the metal material outside the first trench portion 21 using copper etching liquid, so as to form the metal mesh 40.

So far, the metal mesh 40 is manufactured. Certainly, the method for manufacturing the metal mesh 40 is not limited to the above steps S11 to S13, and may further include forming a protective layer on a side of the metal mesh 40 away from the dielectric substrate 10. For example, an organic glue is formed by a leveling process to protect the metal mesh 40.

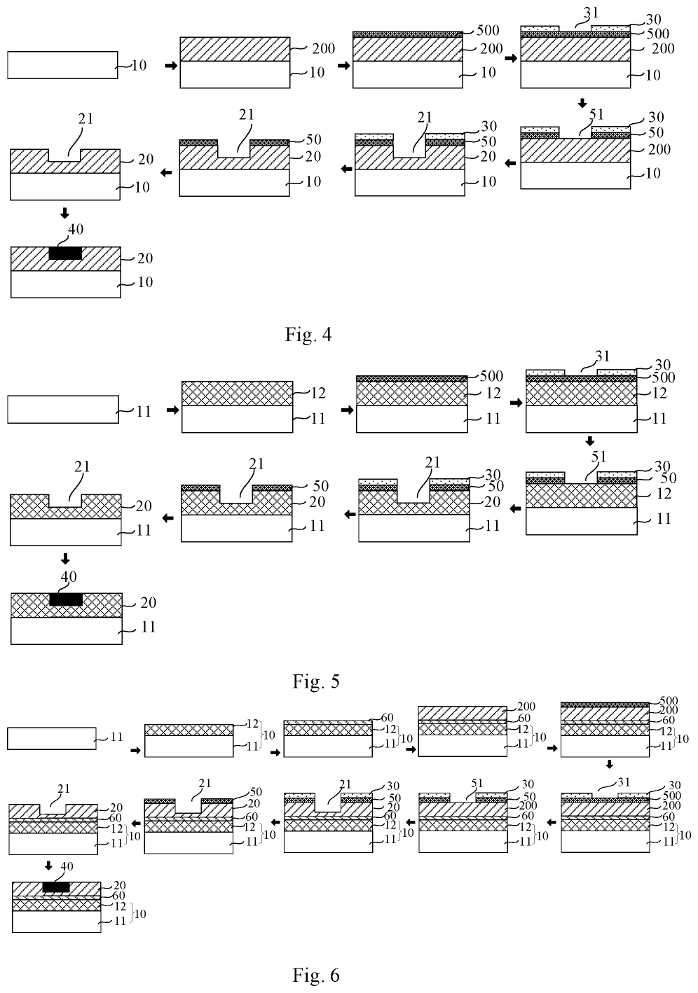

FIG. 4 is a process flow diagram of a method for manufacturing a metal mesh in a second example of the embodiment of the present disclosure; as shown in FIG. 4, the method for manufacturing the metal mesh 40 may include the followings steps S21 to S23.

At step S21, providing a dielectric substrate 10.

The dielectric substrate 10 in the step S21 may be the same as that in the step S11, and therefore, the description thereof is not repeated here.

At step S22, forming a first pattern layer 20 through a patterning process, with the first pattern layer 20 having a first trench portion 21 in a mesh shape.

For example, the step S22 may specifically include steps S221 to S223.

At step S221, forming a second dielectric material layer 200 on the dielectric substrate 10. The second dielectric material layer may be made of an inorganic material such as silicon oxide, silicon nitride and the like, and certainly, may also be made of an organic glue, for example, SOC glue, HR-1201 glue or MR-1301 glue.

For example, the step S221 includes: forming a material layer made of silicon oxide or silicon nitride on a surface of the dielectric substrate 10 by using a physical vapor deposition method, or a chemical vapor deposition method, and the like. A thickness of the material layer made of silicon oxide or silicon nitride ranges from about 4 μm to 5 μm. Alternatively, the step S221 includes: coating an organic glue on the dielectric substrate 10, and then curing the organic glue.

At step S222, forming a pattern including a third dielectric layer 50 on a side, away from the dielectric substrate 10, of the second dielectric material layer 200 through a patterning process, the third dielectric layer 50 having a first hollow-out pattern 51 penetrating through the third dielectric layer 50 along a thickness direction thereof and in a mesh shape.

In some implementations, a material of the third dielectric layer 50 includes, but is not limited to, an inorganic material, a metal oxide, a metal material, and the like. The inorganic material includes silicon nitride (SiNₓ), silicon oxide (SiO₂), silicon oxynitride (SiON), and the like; the metal material includes copper (Cu), aluminum (Al), molybdenum (Mo), silver (Ag); the metal oxide includes indium tin oxide (ITO) and the like. In the implementations of the present disclosure, a case where the material of the third dielectric layer 50 is the inorganic material is taken as an example.

In some implementations, the step S122 may include: sequentially depositing a third dielectric material layer 500 and photoresist on a side of the second dielectric material layer 200 away from the dielectric substrate 10, then performing an exposure and a development on the photoresist, then performing etching process on the third dielectric material layer 500, and after the etching, stripping off the photoresist to form a pattern of the third dielectric layer 50 having the first hollow-out pattern in a mesh shape.

At step S223, etching the second dielectric material layer 200 by using the third dielectric layer 50 as a mask to form a second dielectric layer with a second hollow-out pattern, and removing the third dielectric layer 50. That is, a first epitaxial structure is formed, and the second hollow-out pattern serves as the first trench portion 21.

In some implementations, the step S223 may specifically includes: removing, by using the third dielectric layer 50 as a mask, a portion of the second dielectric material layer 200 at a position of the first hollow-out pattern 51 through the RIE or ICP dry etching, so as to form the first pattern layer 20 having the first trench portion 21.

At step S23, forming a metal mesh 40 on a side of the first pattern layer 20 away from the dielectric substrate 10.

The step S23 may adopt the same process as the step S13 in the first example, and thus, the description thereof is not repeated here.

So far, the metal mesh 40 is manufactured. Certainly, the method for manufacturing the metal mesh 40 is not limited to the above steps S21 to S23, and may further include forming a protective layer on a side of the metal mesh 40 away from the dielectric substrate 10. For example, an organic glue is formed by a leveling process to protect the metal mesh 40.

FIG. 5 is a process flow diagram of a method for manufacturing a metal mesh in a third example of an embodiment of the present disclosure; as shown in FIG. 5, in the method for manufacturing the metal mesh 40 in the third example, the dielectric substrate 10 includes a first dielectric sub-substrate 11 and a second sub-dielectric sub-substrate 12 which are stacked. The first dielectric sub-substrate 11 includes a glass substrate, the second dielectric sub-substrate 12 includes a flexible substrate, and the flexible substrate may be made of at least one of a COP film, Polyimide (PI), or polyethylene terephthalate (PET). The method for manufacturing the metal mesh 40 will be described below, and may includes the following steps S31 to S35.

At step S31, providing the first dielectric sub-substrate 11.

At step S32, coating a transparent optically clear adhesive on the first dielectric sub-substrate 11, and forming the second dielectric sub-substrate 12 on the first dielectric sub-substrate 11.

At step S33, forming a pattern including a third dielectric layer 50 on a side of the second dielectric material layer 200 away from the dielectric substrate 10 through a patterning process, the third dielectric layer 50 having a first hollow-out pattern 51 in a mesh shape, which penetrates through the third dielectric layer 50 along a thickness direction of the third dielectric layer 50.

The step S33 may adopt the same process as the step S222, and thus, the description thereof is not repeated here.

At step S34, etching the second dielectric sub-substrate 12 by using the third dielectric layer 50 as a mask to form the second dielectric sub-substrate 12 with a second hollow-out pattern, and removing the third dielectric layer 50. That is, the first pattern layer 20 is formed, and the second hollow-out pattern serves as the first trench portion 21.

At step S35, forming a metal mesh 40 on a side of the first pattern layer 20 away from the dielectric substrate 10.

The step S35 may adopt the same process as the step S13 in the first example, and thus, the description thereof is not repeated here.

So far, the metal mesh 40 is manufactured. Certainly, the method for manufacturing the metal mesh 40 is not limited to the above steps S21 to S23, and may further include forming a protective layer on a side of the metal mesh 40 away from the dielectric substrate 10. For example, an organic glue is formed by a leveling process to protect the metal mesh 40.

FIG. 6 is a process flow diagram of a method for manufacturing a metal mesh in a fourth example of an embodiment of the present disclosure; as shown in FIG. 6, the method for manufacturing the metal mesh 40 specifically includes the following steps S41 to S43.

At step S41, providing a dielectric substrate 10.

The dielectric substrate 10 in the step S41 may be the same as that in the step S11, and therefore, the description thereof is not repeated here. In FIG. 6, a case where the dielectric substrate 10 includes a first dielectric sub-substrate 11 and a second dielectric sub-substrate 12 which are stacked is taken as an example.

At step S42, forming a buffer layer 60 on the dielectric substrate 10.

The step S42 may include: forming the buffer layer 60 on a surface of the dielectric substrate 10 by using a physical vapor deposition method or a chemical vapor deposition method, and the like, where a material of the buffer layer 60 includes an inorganic material such as silicon nitride (SiNₓ), silicon oxide (SiO₂), silicon oxynitride (SiON), or the like.

At step S43, forming a first pattern layer 20 through a patterning process, with the first pattern layer 20 having a first trench portion 21 in a mesh shape.

For example, the step S42 may specifically include steps S421 to S423.

At step S421, forming a second dielectric material layer 200 on the dielectric substrate 10 by using an inorganic material such as silicon oxide, silicon nitride or the like, or by using an organic glue such as SOC glue, HR-1201 glue or MR-1301 glue.

For example, the step S421 includes: forming a material layer made of silicon oxide or silicon nitride on a surface of the dielectric substrate 10 by a physical vapor deposition method, or a chemical vapor deposition method, and the like. A thickness of the material layer made of silicon oxide or silicon nitride ranges from about 4 μm to 5 μm. Alternatively, the step S421 includes: coating an organic glue on the dielectric substrate 10, and then curing the organic glue.

At step S422, forming a pattern including a third dielectric layer 50 on a side of the second dielectric material layer 200 away from the dielectric substrate 10 through a patterning process, the third dielectric layer 50 having a first hollow-out pattern 51 in a mesh shape, which penetrates through the third dielectric layer 50 along a thickness direction of the third dielectric layer 50.

In some implementations, a material of the third dielectric layer 50 includes, but is not limited to, an inorganic material, a metal oxide, a metal material, and the like. The inorganic material includes silicon nitride (SiNₓ), silicon oxide (SiO₂), silicon oxynitride (SiON), and the like; the metal material includes copper (Cu), aluminum (Al), molybdenum (Mo), silver (Ag); the metal oxide includes indium tin oxide (ITO) and the like. In the implementations of the present disclosure, a case where the material of the third dielectric layer 50 is the inorganic material is taken as an example.

In some implementations, the step S422 may include: sequentially depositing a third dielectric material layer 500 and photoresist on a side of the second dielectric material layer 200 away from the dielectric substrate 10, then performing an exposure and a development on the photoresist, then performing etching on the third dielectric material layer 500, and after the etching, stripping off the photoresist to form a pattern of the third dielectric layer 50 having the first hollow-out pattern in a mesh shape.

At step S423, etching the second dielectric material layer 200 by using the third dielectric layer 50 as a mask to form a second dielectric layer with a second hollow-out pattern, and removing the third dielectric layer 50. That is, a first epitaxial structure is formed, and the second hollow-out pattern serves as the first trench portion 21.

In some implementations, the step S423 may specifically includes: removing, by using the third dielectric layer 50 as a mask, a portion of the second dielectric material layer 200 at a position of the first hollow-out pattern 51 using the RIE or ICP dry etching, so as to form the second pattern layer 20 having the second hollow-out pattern, that is, the first pattern layer 20 is formed, and the second hollow-out pattern serves as the first trench portion 21.

At step S43, forming a metal mesh 40 on a side of the first pattern layer 20 away from the dielectric substrate 10.

So far, the metal mesh 40 is manufactured. Certainly, the method for manufacturing the metal mesh 40 is not limited to the above steps S21 to S23, and may further include forming a protective layer on a side of the metal mesh 40 away from the dielectric substrate 10. For example, an organic glue is formed by a leveling process to protect the metal mesh 40.

FIG. 7 is a process flow diagram of a method for manufacturing a metal mesh in a fifth example of an embodiment of the present disclosure, referring to FIGS. 6 and 7, the method for manufacturing the metal mesh 40 specifically includes the following steps S51 to S53.

At step S51, providing a dielectric substrate 10.

The dielectric substrate 10 in the step S51 may be the same as that in the step S11, and therefore, the description thereof is not repeated here. In FIGS. 6 and 7, a case where the dielectric substrate 10 includes the first dielectric sub-substrate 11 and the second dielectric sub-substrate 12 which are stacked is taken as an example.

At step S52, forming a first pattern layer 20 through a patterning process, with the first pattern layer 20 having a first trench portion 21 in a mesh shape.

The step S52 may be the same as the step S22, and thus, the description thereof is not repeated here.

At step S53, forming a first dielectric layer 70 on a side of the first pattern layer 20 away from the dielectric substrate 10 to form a second trench portion 71. A material of the first dielectric layer 70 is different from that of the first pattern layer 20, one of the material of the first dielectric layer 70 and the material of the first pattern layer 20 is an organic material, and the other of the material of the first dielectric layer 70 and the material of the first pattern layer 20 is an inorganic material.

For example, the material of the first pattern layer 20 in the example of the present disclosure is the organic material (e.g., an organic glue), and the material of the first dielectric layer 70 is the inorganic material (e.g., silicon oxide, silicon nitride, and the like).

It should be noted that the second trench portion 71 is actually a blind trench structure defined by the first dielectric layer 70 deposited on the side wall of the first trench portion 21, that is, the second trench portion 71 is formed, where a width of the first trench portion 21 is a first width W1, a width of the second trench portion 71 is a second width W2, and obviously W2<W1, and the width W2 of the second trench portion 71 depends on a thickness of the first dielectric layer 70. For example, the thickness of the first dielectric layer 70 is d, and (W1−W2)=1.2×d.

At step S54, forming a metal material, which is located in the second trench 71, on a side of the first dielectric layer 70 away from the dielectric substrate 10 through a patterning process to form a metal mesh 40.

The step S54 may be the same as the step S13, and therefore will not be described herein.

So far, the metal mesh 40 is manufactured. Certainly, the method for manufacturing the metal mesh 40 is not limited to the above steps S51 to S54, and may further include forming a protective layer on a side of the metal mesh 40 away from the dielectric substrate 10. For example, an organic glue is formed by a leveling process to protect the metal mesh 40.

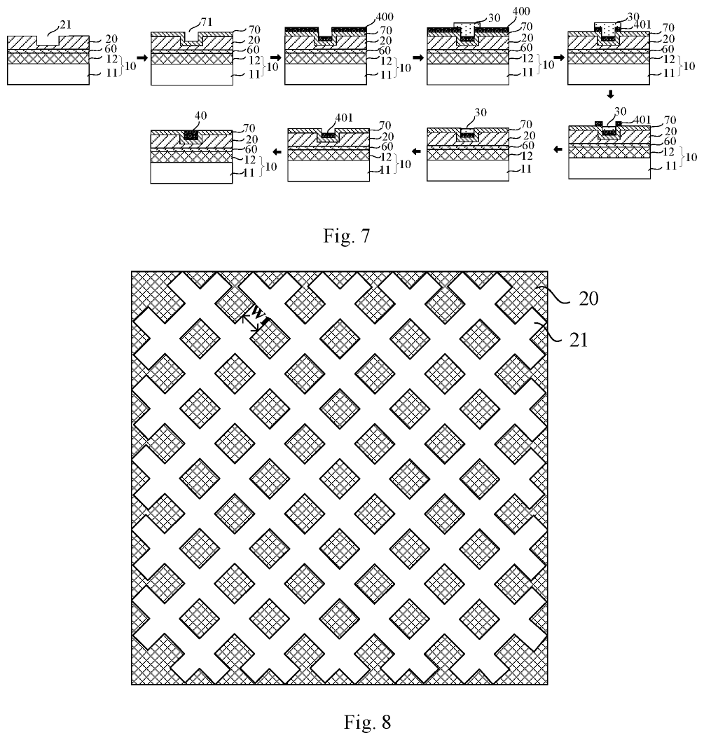

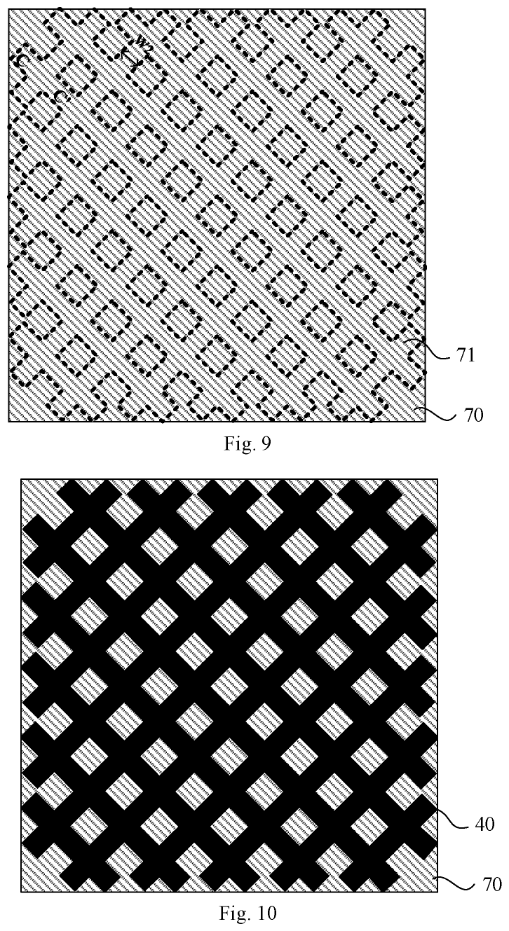

FIG. 8 is a top view of a first pattern layer formed in a method for manufacturing a metal mesh in a sixth example of an embodiment of the present disclosure; FIG. 9 is a top view of a first dielectric layer formed in a method for manufacturing a metal mesh in the sixth example of the embodiment of the present disclosure; FIG. 10 is a top view of a metal mesh formed in a method for manufacturing the metal mesh in the sixth example of the embodiment of the present disclosure, referring to FIG. 6 to FIG. 10, the method for manufacturing the metal mesh 40 specifically includes the following steps S61 to S65.

At step S61, providing a dielectric substrate 10.

The dielectric substrate 10 in the step S61 may be the same as that in the step S11, and therefore, the description thereof is not repeated herein.

At step S62, forming a buffer layer 60 on the dielectric substrate 10.

The step S62 may include: forming the buffer layer 60 on a surface of the dielectric substrate 10 by using a physical vapor deposition method, or a chemical vapor deposition method, and the like, where a material of the buffer layer 60 includes an inorganic material such as silicon nitride (SiNₓ), silicon oxide (SiO₂), silicon oxynitride (SiON), and the like.

At step S63, forming a first pattern layer 20 through a patterning process, with the first pattern layer 20 having a first trench portion 21 in a mesh shape.

For example, the step S63 may specifically include steps S631 to S633.

At step S631, forming a second dielectric material layer 200 on the dielectric substrate 10 by using an inorganic material such as silicon oxide, silicon nitride and the like, or by using an organic glue such as SOC glue, HR-1201 glue or MR-1301 glue.

For example, the step S631 includes: forming a material layer made of silicon oxide or silicon nitride on a surface of the dielectric substrate 10 by a physical vapor deposition method or a chemical vapor deposition method, and the like. A thickness of the material layer made of silicon oxide or silicon nitride ranges from about 4 μm to 5 μm. Alternatively, the step S631 includes: coating an organic glue on the dielectric substrate 10, and then curing the organic glue.

At step S632, forming a pattern including a third dielectric layer 50 on a side of the second dielectric material layer 200 away from the dielectric substrate 10 through a patterning process, the third dielectric layer 50 having a first hollow-out pattern 51 in a mesh shape, which penetrates through the third dielectric layer 50 along a thickness direction of the third dielectric layer 50.

In some implementations, a material of the third dielectric layer 50 includes, but is not limited to, an inorganic material, a metal oxide, a metal material, and the like. The inorganic material includes silicon nitride (SiNₓ), silicon oxide (SiO₂), silicon oxynitride (SiON), and the like; the metal material includes copper (Cu), aluminum (Al), molybdenum (Mo), silver (Ag); the metal oxide includes indium tin oxide (ITO) and the like. In the implementations of the present disclosure, a case where the material of the third dielectric layer 50 is the inorganic material is taken as an example.

In some implementations, the step S632 may include: sequentially depositing a third dielectric material layer 500 and photoresist 30 on a side of the second dielectric material layer 200 away from the dielectric substrate 10, then performing an exposure and a development on the photoresist (the pattern of the photoresist is denoted by 31), then performing etching process on the third dielectric material layer 500, and after the etching, stripping off the photoresist to form a pattern of the third dielectric layer 50 having the first hollow-out pattern in a mesh shape.

At step S633, etching the second dielectric material layer 200 by using the third dielectric layer 50 as a mask to form a second dielectric layer with a second hollow-out pattern, and removing the third dielectric layer 50. That is, the first pattern layer is formed, and the second hollow-out pattern serves as the first trench portion 21.

In some implementations, the step S633 may specifically includes: removing, by using the third dielectric layer 50 as a mask, a portion of the second dielectric material layer 200 at a position of the first hollow-out pattern 51 using the RIE or ICP dry etching, so as to form the second pattern layer 20 having the second hollow-out pattern, that is, form the first pattern layer 20.

At step S64, forming a first dielectric layer 70 on a side of the first pattern layer 20 away from the dielectric substrate 10, and the first dielectric layer 70 including a second trench portion 71. A material of the first dielectric layer 70 is different from that of the first pattern layer 20, one of the material of the first dielectric layer 70 and the material of the first pattern layer 20 is an organic material, and the other of the material of the first dielectric layer 70 and the material of the first pattern layer 20 is an inorganic material.

For example, the material of the first pattern layer 20 in the example of the present disclosure is the organic material (e.g., an organic glue), and the material of the first dielectric layer 70 is the inorganic material (e.g., silicon oxide, silicon nitride, and the like).

It should be noted that the second trench portion 71 is actually a blind trench structure defined by the first dielectric layer 70 deposited on the side wall of the first trench portion 21, that is, the second trench portion 71 is formed, where a width of the first trench portion 21 is a first width W1, a width of the second trench portion 71 is a second width W2, and obviously W2<W1, and the width W2 of the second trench portion 71 depends on a thickness of the first dielectric layer 70. For example, the thickness of the first dielectric layer 70 is d, and (W1−W2)=1.2×d.

At step S65, forming a metal material, located in the second trench portion 71, on a side of the first dielectric layer 70 away from the dielectric substrate 10 through a patterning process to form the metal mesh 40.

The step S65 may be the same as the step S13, and therefore will not be described herein.

In some implementations, as shown in FIG. 7, the step S65 may include the following steps S651 to S654.

At step S651, sequentially depositing a titanium film and a copper film, i.e., forming a metal film 400, on the side of the first pattern layer 20 away from the dielectric substrate 10 by a process including, but not limited to, sputtering.

It should be noted that only the copper film may be deposited in this step, and the titanium film is used to increase adhesion of the copper film.

At step S652, taking the metal thin film 400 as a seed layer, coating photoresist on the seed layer, then removing a portion of the photoresist through a patterning process, with the remained photoresist covering the second trench portion 71 and a portion of the metal film 400 outside the second trench portion 71; and removing the exposed metal film 400 by using wet etching, where the remained portion of the metal film is denoted by 401.

At step S653, removing a portion of the photoresist 30 in a thickness direction thereof by dry etching so as to only remain a portion of the photoresist 30 in the second trench portion; removing the exposed metal film 401 by wet etching, and removing the remained portion of the photoresist 30 by dry etching.

At step S654, electroplating on the remained metal film 401 to form a metal mesh 40 (see FIG. 7).

In some implementations, the step S652 specifically includes: placing a side of the dielectric substrate 10 having the first pattern layer 20 formed thereon on a carrier of an electroplating machine, pressing an electricity-applying pad on the dielectric substrate, placing the dielectric substrate in a hole-filling electroplating tank (a dedicated hole-filling electroplating solution being used in the tank), applying a current to the electricity-applying pad so that the electroplating solution keeps flowing continuously and rapidly on the surface of the dielectric substrate 10, cations in the electroplating solution on a side wall of the first trench portion 21 capture electrons and become atoms to be deposited on the side wall, and by using the dedicated hole-filling electroplating solution with specific formulation, the metal copper can be mainly deposited in the second trench portion 71 at a relatively high deposition rate (ranging from 0.5 μm/min to 3 μm/min), while the deposition rate of the metal copper on the first pattern layer 20 is extremely small (ranging from 0.005 μm/min to 0.05 μm/min). With the increase of time, the metal copper on the side wall of the second trench portion 71 grows gradually to be thicker, and even can completely fill the second trench portion 71, and finally the dielectric substrate 10 is taken out and cleaned by using deionized water.

So far, the metal mesh 40 is manufactured. Certainly, the method for manufacturing the metal mesh 40 is not limited to the above steps S61 to S65, and may further include forming a protective layer on a side of the metal mesh 40 away from the dielectric substrate 10. For example, an organic glue is formed by a leveling process to protect the metal mesh 40.

The method for manufacturing the metal mesh 40 in a seventh example is substantially the same as that in the sixth example, except that in the seventh example, a refractive index of the first dielectric layer 70 is adjusted to be the same as or substantially the same as that of the first pattern layer 20 by adjusting deposition parameters for forming the first dielectric layer 70, so as to ensure that the metal mesh 40 formed is transparent.

In some implementations, the refractive index of the first dielectric layer 70 is the same as that of the first pattern layer 20 or different from that of the first pattern layer 20 by less than 1%, even less than 0.5%, so that the problem of dispersion occurring after light irradiates the first dielectric layer 70 and the first pattern layer 20 can be avoided, and a transparent structure of the metal mesh 40 can be realized.

For example, a width of the first trench portion 21 is controlled to be less than 3.2 μm during etching the first pattern layer 20, so that the refractive index of the first dielectric layer 70 may be different from the refractive index of the first pattern layer 20 in a case of depositing SiON, but the difference between the refractive index of the first dielectric layer 70 and the refractive index of the first pattern layer 20 is desired to be less than ±0.03, a deposition thickness of the first dielectric layer 70 is less than 1.5 μm. Since a width of a metal line is desired to be less than 2 μm to realize visual fully transparency, the width of the first trench portion 21 is desired to be controlled to be less than 3.2 μm during etching the first pattern layer 20, so that the width of the first trench portion 21 can be narrowed to about 2 μm after growing the first dielectric layer 70 with a width of about 1.5 μm.

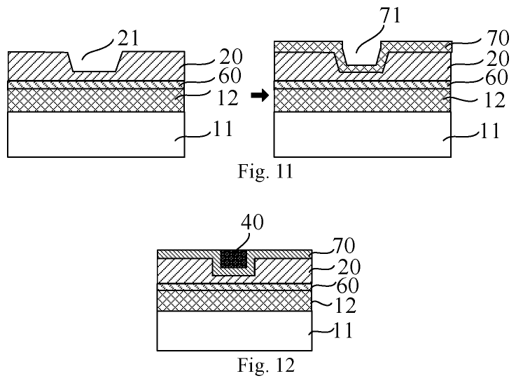

FIG. 11 is a schematic diagram of a first trench portion and a second trench portion formed in a method for manufacturing a metal mesh according to an embodiment of the present disclosure, in some implementations, as shown in FIG. 11, a longitudinal section of the first trench portion 21 in the first pattern layer 20 formed by any method mentioned above may be an inverted trapezoid with a gradient angle ranging from about 70° to about 80°, in such case, the difference between the refractive index of the first dielectric layer 70 and the refractive index of the first pattern layer 20 is less than ±0.01, so as to ensure that the metal mesh 40 formed is transparent.

In addition, if the metal is not fully filled in the trench portion, an organic glue having a refractive index the same as that of the first dielectric layer 70 and the first pattern layer 20 or having a refractive index different from that of the first dielectric layer 70 and the first pattern layer 20 by less than 1% is desired to be filled in the trench portion by leveling, so as to ensure that the metal mesh 40 formed is transparent.

In a second aspect, the present disclosure further provides a method for manufacturing a thin film sensor including, but not limited to, a transparent antenna, the method may include the above-mentioned method for manufacturing the metal mesh 40.

Since the method for manufacturing the thin film sensor in the present disclosure includes the method for manufacturing the metal mesh 40 described above, the transmittance of the thin film sensor formed by the method is relatively high, and the influence on the optical effect of the display device is obviously reduced in a case where the thin film sensor is applied to the display device.

In a third aspect, an embodiment of the present disclosure provides a thin film sensor, which may be manufactured using the method mentioned above. The thin film sensor includes, but is not limited to, a transparent antenna. The metal mesh 40 in the thin film sensor in the embodiment of the present disclosure is manufactured by any method mentioned above, so the a line width of the metal mesh 40 is relatively narrow, for example, not greater than 2 μm, even less than 1.5 μm.

FIG. 12 is a cross-sectional diagram of a metal mesh in an example of the present disclosure; referring to FIG. 12, the thin film sensor in the embodiment of the present disclosure includes a dielectric substrate 10, a first pattern layer 20, a first dielectric layer 70, and a metal mesh 40. The first pattern layer 20 is arranged on the dielectric substrate 10 and has a first trench portion 21 in a mesh shape, the first dielectric layer 70 is formed on a side of the first pattern layer 20 away from the dielectric substrate 10 and formed therein with a second trench portion 71 in a mesh shape, and the metal mesh 40 is formed in the second trench portion 71. That is, an orthographic projection of the metal mesh 40 on a substrate base is located within an orthographic projection of the first dielectric layer 70 on the substrate base. One of the first dielectric layer 70 and the first pattern layer 20 is made of an organic material, and the other of the first dielectric layer 70 and the first pattern layer 20 is made of an inorganic material.

In some implementations, a refractive index of the first dielectric layer 70 is the same as that of the first pattern layer 20 or different from that of the first pattern layer 20 by less than 1%, even less than 0.5%, so that the problem of dispersion occurring after light irradiates the first dielectric layer 70 and the first pattern layer 20 can be avoided, and a transparent structure of the metal mesh 40 can be realized.

In some implementations, a material of the first pattern layer 20 includes an organic glue, for example, SOC glue, HR-1201 glue or MR-1301 glue. A material of the first dielectric layer 70 includes silicon oxide, silicon nitride, silicon oxynitride, etc.

The metal mesh 40 in the thin film sensor in the embodiment of the present disclosure may be manufactured by any method described above, and thus, each film layer structure in the thin film sensor in the embodiment of the present disclosure may be made of the same material as that described above, and therefore, the details thereof are not repeated herein.

It will be understood that the above embodiments are merely exemplary embodiments adopted to illustrate the principles of the present disclosure, but the present disclosure is not limited thereto. It will be apparent to those skilled in the art that various modifications and improvements can be made without departing from the spirit and scope of the present disclosure, and such modifications and improvements are also considered to be within the scope of the present disclosure.

1. A method for manufacturing a conductive mesh, comprising:
providing a dielectric substrate;
forming a first pattern layer on a side of the dielectric substrate through a patterning process, the first pattern layer having a first trench portion in a mesh shape;
forming a first dielectric layer on a side of the first pattern layer away from the dielectric substrate, the first dielectric layer being formed therein with a second trench portion in a mesh shape, one of a material of the first dielectric layer and a material of the first pattern layer being an organic material, and the other of the material of the first dielectric layer and the material of the first pattern layer being an organic material; and
forming, on a side of the first dielectric layer away from the dielectric substrate, a conductive material in the second trench portion to form a conductive mesh.

2. The method according to claim 1, wherein the forming a first pattern layer on a side of the dielectric substrate through a patterning process comprises:
depositing a second dielectric material layer on the dielectric substrate and curing the second dielectric material layer;
forming a third dielectric material layer on a side of the second dielectric material layer away from the dielectric substrate, and performing a patterning process on the third dielectric material layer to form a third dielectric layer with a first hollow-out pattern therein;
etching the second dielectric material layer by taking the third dielectric layer as a mask to form a second dielectric layer with a second hollow-out pattern therein;
removing the third dielectric layer, so that the second dielectric layer serves as the first pattern layer, and the second hollow-out pattern serves as the first trench portion.

3. The method according to claim 2, wherein the performing a patterning process on the third dielectric material layer to form a third dielectric layer with a first hollow-out pattern therein comprises: forming the third dielectric layer with the first hollow-out pattern by wet etching.

4. The method according to claim 2, wherein the etching the second dielectric material layer to form a second dielectric layer with a second hollow-out pattern comprises: performing dry etching on the second dielectric material layer to form the second dielectric layer with the second hollow-out pattern therein.

5. The method according to claim 1, wherein a width of the first trench portion is W1, a width of the second trench portion is W2, a thickness of the first dielectric layer is d, and (W1−W2)=1.2×d.

6. The method according to claim 1, wherein a difference between refractive indexes of the first dielectric layer and the second dielectric layer is not greater than 1%.

7. The method according to claim 1, wherein a material of the first dielectric layer includes silicon nitride or silicon oxide.

8. The method according to claim 1, wherein a material of the second dielectric layer includes an organic glue.

9. The method according to claim 1, wherein the forming, on a side of the first dielectric layer away from the dielectric substrate, a conductive material in the second trench portion to form a conductive mesh comprises:
sequentially depositing a metal film and photoresist on a side of the third dielectric material layer away from the dielectric substrate by an electron beam evaporation apparatus, and forming a metal material located in the second trench portion through exposure, development and etching, so as to form the conductive mesh.

10. The method according to claim 1, wherein the forming, on a side of the first dielectric layer away from the dielectric substrate, a conductive material in the second trench portion to form a conductive mesh comprises:
forming a metal film serving as a seed layer on a side of the third dielectric material layer away from the dielectric substrate;
electroplating on the seed layer to form a metal material in the second trench portion and on a side of the third dielectric material layer away from the dielectric substrate; and
removing at least the metal material outside the second trench portion to form the metal material located in the second trench portion, so as to form the conductive mesh.

11. The method according to claim 1, wherein the providing a dielectric substrate comprises: providing a first dielectric sub-substrate, and forming a second dielectric sub-substrate on the first dielectric sub-substrate, the second dielectric sub-substrate comprising a flexible substrate.

12. The method according to claim 1, further comprising: forming a buffer layer on the dielectric substrate before forming the first pattern layer.

13. A method for manufacturing a thin film sensor, comprising the method according to claim 1.

14. A thin film sensor, comprising:
a dielectric substrate;
a first pattern layer arranged on the dielectric substrate and provided with a first trench portion in a mesh shape;
a first dielectric layer arranged on a side, away from the dielectric substrate, of the first pattern layer, and formed with a second trench portion in a mesh shape therein, wherein one of a material of the first dielectric layer and a material of the first pattern layer includes an organic material, and the other of the material of the first dielectric layer and the material of the first pattern layer includes an inorganic material; and
a conductive mesh arranged on a side of the first dielectric layer away from the dielectric substrate, and an orthographic projection of the conductive mesh on the dielectric substrate is located within an orthographic projection of the first dielectric layer on the dielectric substrate.

15. The thin film sensor of claim 14, wherein a difference between refractive indexes of the material of the first dielectric layer and the material of the first pattern layer is not greater than 1%.

16. The thin film sensor of claim 14, wherein the material of the first dielectric layer includes silicon nitride or silicon oxide.

17. The thin film sensor of claim 14, wherein the material of the first pattern layer includes an organic glue.

18. The method according to claim 2, wherein a width of the first trench portion is W1, a width of the second trench portion is W2, a thickness of the first dielectric layer is d, and (W1−W2)=1.2×d.

19. The method according to claim 2, wherein a difference between refractive indexes of the first dielectric layer and the second dielectric layer is not greater than 1%.

20. The method according to claim 3, wherein a material of the first dielectric layer includes silicon nitride or silicon oxide.
